(19) United States
(12) Patent Application Publication
(10) Pub. No.: US 2002/0107027 A1
(43) Pub. Date: Aug. 8, 2002

(54) Targeted advertising for commuters with mobile IP terminals

(76) Inventor: Joseph Thomas O'Neil, Staten Island, NY (US)

Correspondence Address: Mr. S. H. Dworetsky, AT&T Corp., P.O. Box 4110, Middletown, NJ, 07748, US

(21) Appl. No.: 09/731,211

(22) Filed: Dec. 6, 2000

(51) Int. Cl. H04M 3/42; H04Q 7/20

(52) U.S. Cl. 455/456; 455/414

(57) ABSTRACT

An advertising server stores data of both consumers and merchants. Consumer data includes samples of a consumer's location at various points along routes taken by a consumer's mobile IP terminal. Merchant data includes the geographic locations of the merchant's stores. The advertising server uses the consumer and merchant data to select merchants located in proximity to paths frequently traveled by a consumer. Merchant selection may take into account other factors such as demographics. The advertising server then provides selected merchant servers with an opportunity to have the advertising server deliver advertisements to the consumer on the merchant's behalf. Based on consumer data provided by the advertising server and predetermined criteria established by the merchant, each merchant server transmits an advertisement and a “willingness to pay” to the advertising server. The advertising server receives the responses and transmits to the consumer the advertisements associated with a sufficient willingness to pay for delivery.

### FIELD OF THE INVENTION

This invention relates generally to wireless data communications systems, and more particularly, to a method and apparatus directed to conveying advertising information to users of mobile IP terminals.

### BACKGROUND OF THE INVENTION

There are dozens of different electronic media in use today for advertising a product or service to potential customers. These range from banner ads on a web page to commercials on a set-top box. It is also known in the art to provide advertising to buyers over a wireless connection based upon a buyer's current location. These systems, however, provide merchants with little or no information about the buyer other than her current location, and thus, do not permit merchants to differentiate between potential buyers in any meaningful way. Although some wireless systems that provide geographically-dependent information permit buyers to specify the types of information sought (through the use of search queries and the like), these systems require buyers to seek out sellers of particular goods or services, and thus, do not enable merchants to identify potential buyers who have neither the time nor the inclination for such activities.

### SUMMARY OF THE INVENTION

The above-identified problems are solved and a technical advance is achieved in the art by providing a system and method directed to conveying advertising to users of a wireless terminal. An exemplary method of selecting merchants for transmission of advertising information to a user of a mobile wireless terminal includes: comparing a plurality of geographic location samples of a wireless terminal with a geographic location of a seller to determine whether the wireless terminal has frequently traveled in proximity to the seller; and if the wireless terminal has frequently traveled in proximity to the seller, selecting the seller as an entity that may be interested in having an advertisement transmitted to a user of the terminal.

A method is also disclosed of conveying advertising information to users of mobile wireless terminals. An exemplary method includes: receiving location samples of a mobile wireless terminal; processing the location samples to determine whether the wireless terminal frequently travels in proximity to a seller; and transmitting an advertisement of the seller to a user of the wireless terminal.

An alternate method of conveying advertising information to users of mobile wireless terminals includes: determining if a buyer is traveling in proximity to a seller; and if demographics information of the buyer satisfies predetermined criteria, transmitting an advertisement of a seller to the buyer.

A method of conveying advertisements to a commuter in a vehicle is also disclosed. An exemplary method includes: receiving vehicle statistics; transmitting the vehicle statistics to a selected merchant; receiving an advertisement of the selected merchant; and presenting the advertisement to the commuter.

In addition, a method for a merchant to advertise to a user of a mobile wireless terminal is disclosed. An exemplary method includes receiving information regarding the frequency with which the user is in proximity to a location of the merchant; selecting an advertisement to be transmitted to the user; and transmitting the advertisement to an advertising server.

Other and further aspects of the present invention will become apparent during the course of the following description and by reference to the attached drawings.

### BRIEF DESCRIPTION OF THE DRAWINGS

FIG. 1 is a block diagram illustrating one embodiment of the present invention.

FIG. 2 depicts a block diagram of an exemplary advertising server.

FIG. 3 illustrates exemplary databases utilized by the advertising server.

FIG. 4 depicts a block diagram of an exemplary merchant server.

FIG. 5 illustrate exemplary databases utilized by the merchant server.

FIG. 6 is a flow chart illustrating an exemplary process by which a mobile IP terminal transmits location samples to an advertising server.

FIG. 7 is a flow chart illustrating an exemplary process by which an advertising server stores data received from a mobile IP terminal.

FIG. 8 is a flow chart illustrating an exemplary process by which an advertising server updates the selected merchants database based on data received from a mobile IP terminal.

FIG. 9 is a flow chart illustrating an exemplary process by which an advertising server communicates with selected merchants regarding the delivery of advertisements.

FIG. 10 is a flow chart illustrating an exemplary process by which a merchant server transmits an advertisement to an advertising server.

FIG. 11 depicts a block diagram of an enhanced mobile IP terminal of a second embodiment of the present invention.

FIG. 12 is flow chart illustrating an exemplary process by which the location sampler of the enhanced mobile IP terminal samples the terminal's location.

FIG. 13 is flow chart illustrating an exemplary process by which location processor of the enhanced mobile IP terminal performs merchant selection and presents advertisements.

FIG. 14 is a flow chart illustrating an exemplary process by which the writer module of the enhanced mobile IP terminal uploads entries in selected merchant table to the advertising server.

FIG. 15 is a flow chart illustrating an exemplary process by which the advertisement reader module of the enhanced mobile IP terminal receives and stores advertisements from the advertising server.

FIG. 16 depicts a block diagram of a “smart” automobile of yet an another embodiment of the present invention.

FIG. 17 is a flow chart illustrating an exemplary process by which a smart automobile presents advertisements to a commuter as the commuter approaches a selected merchant.

### DETAILED DESCRIPTION

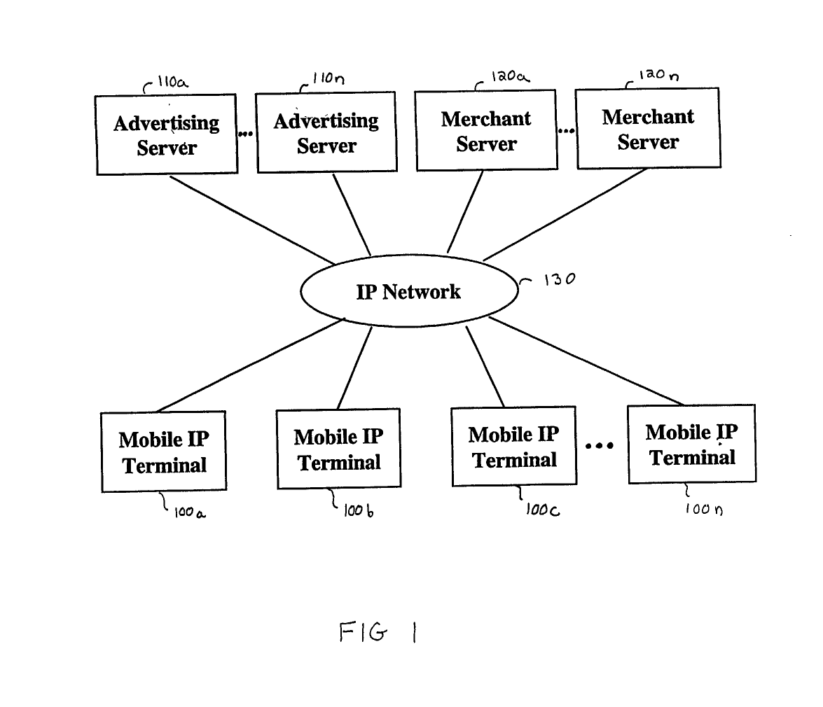

Referring now to the drawings, FIG. 1 is a block diagram of an illustrative embodiment of the present invention. As depicted therein, a plurality of mobile IP terminals 100, a plurality of advertising servers 110 and a plurality of merchant servers 120 are “coupled” to an IP network 130. Mobile IP terminals 100 may be coupled to the IP network 130 via a wireless switching network, the public switched telephone network (PSTN) and an Internet Service Provider (ISP). The advertising servers 110 and merchant servers 120 may be coupled to IP network 130 via the PSTN and an ISP.

In accordance with the present invention, an advertising server 110 stores data of both consumers and merchants. Consumer data includes samples of a consumer's location at various points along routes taken by a consumer's mobile IP terminal 100. This data can be inferred from GPS measurements that are periodically collected by the mobile IP terminal 100 while in transit and uploaded to an advertising server 110 via the IP network 130. Mobile IP terminal 100 is configured with a GPS system and the IP address of an advertising server 110 to which the mobile IP terminal 100 has been assigned to report its location; each mobile IP terminal 100 is assigned to only one advertising server 110. Merchant data stored in advertising server 110 includes the geographic locations of the merchant's stores. This data is provided by merchants during system configuration.

In an exemplary embodiment, advertising server 110 uses the consumer and merchant data (e.g., location information) to select merchants located in proximity to paths frequently traveled by a consumer. A consumer who is frequently in proximity to a merchant is a likely candidate for the merchant to target with special offers primarily because of the convenience associated with shopping at stores located along frequently traveled routes. Merchant selection may take into account other factors, in addition to location information, such as timing information, consumer demographics, specific consumer instructions regarding the types of merchants from whom the consumer is willing to receive advertisements or any other information that will increase the likelihood of a successful match. The merchants selected by advertising server 110 are referred to hereinafter as “selected merchants”. Advertising server 110 then offers the appropriate merchant servers 120 (i.e., those corresponding to the selected merchants) with the opportunity to have advertising server 110 deliver advertisements to the consumer on the merchant's behalf. The offer includes consumer data such as, e.g., the location samples together with associated dates/times, demographics information and any other information that may assist the merchant servers 120 in deciding whether to have advertising server 110 advertise to the particular consumer.

Based on consumer data provided by advertising server 110 and predetermined criteria established by the merchant, each merchant server 120 determines whether to have advertising server 110 transmit an advertisement to the consumer, the type of advertisement to be transmitted, and the amount the merchant is willing to pay for the transmission. Each merchant server 120 then transmits the advertisement and the “willingness to pay” to advertising server 110 in the form of a response. Advertising server 110 receives the responses and transmits to the consumer the advertisements associated with a sufficient willingness to pay for delivery. Transmission of an advertisement may be by way of various media including e-mail, voice mail, facsimile, paper media (such as catalogs), banner ads, television commercials, and the like.

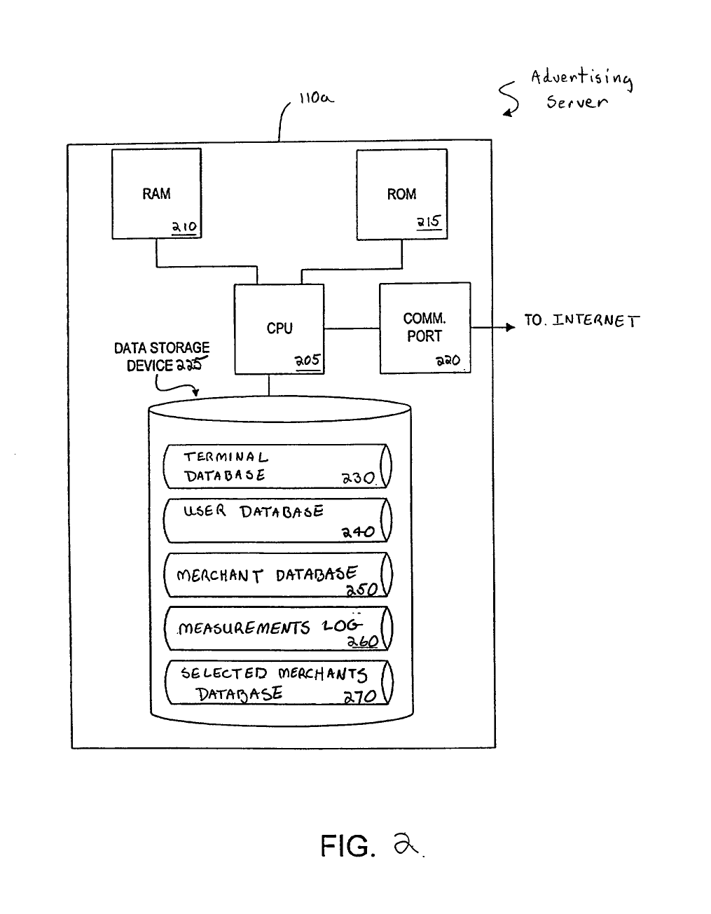

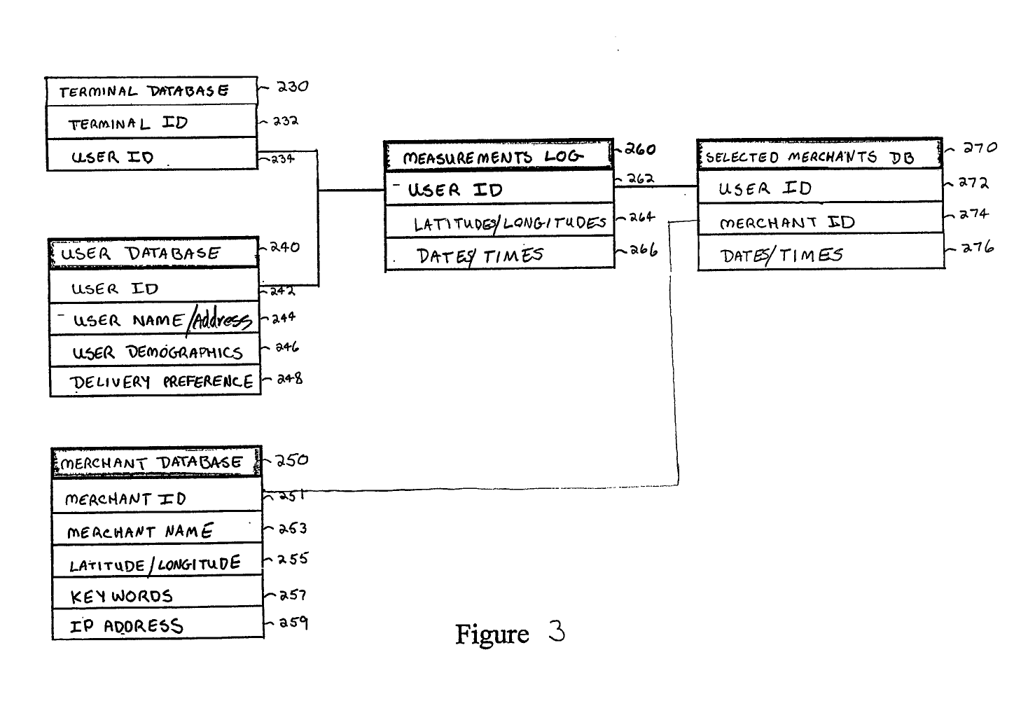

FIG. 2 depicts a block diagram of an exemplary advertising server 110. The server 110 includes a CPU 205 together with associated memory (210, 215) for performing a variety of processes. Briefly, these processes include receiving and storing time-varying location samples of a plurality of consumers, storing the geographic locations of a plurality of merchants, determining selected merchants (i.e., those located at points that the consumer frequently travels in proximity thereof), providing selected merchants with an opportunity to advertise to consumers, and transmitting their advertisements to consumers. The CPU 205 is coupled to an IP network 130 via a communications port 220, which is used to communicate with mobile IP terminals 100 and merchant servers 120. As shown in FIG. 2, CPU 205 is also coupled to a data storage device 225. Data storage device 225 includes a variety of databases including terminal database 230, user database 240, merchant database 250, measurements log 260 and selected merchants database 270, which will be discussed in detail below in connection with FIG. 3.

FIG. 3 illustrates exemplary databases utilized by the advertising server 120. These include terminal database 230, user database 240, merchant database 250, measurements log 260 and selected merchants database 270. Although not intended to be limiting, these databases are preferably relational databases comprising a plurality of tables linked by a common field. As shown in FIG. 3, all of the databases except for the merchant database are linked by the common field entitled “User ID”.

Terminal database 230 stores information necessary for the advertising server 110 to translate a terminal ID of a mobile IP terminal into a user ID of the individual associated with the terminal; each mobile IP terminal has a unique terminal ID used for identifying its transmissions to the advertising server 110. As such, this database has fields for terminal ID 232 and user ID 234. User database 240 stores detailed information about the user. It has fields for information such as the user ID 242, user name 244, user demographics 246 and user delivery preferences 248. With respect to user delivery preferences, a user may specify the type of medium over which he is willing to accept advertisements.

Measurements log 260 stores samples of a user's geographic position. These samples are received periodically from a mobile IP terminal 100. The measurements log contains fields for a user ID 262 as well as the latitude/longitude 264 and date/time 266 of the sample. Selected merchants database 270 stores information concerning selected merchants—namely, those located in proximity of the samples that most frequently appear in the measurements log 260. Database 270 includes fields for a user ID 272, merchant ID 274 and dates/times of the samples 276.

Merchant database 250 stores detailed information about merchants and has fields for information such as the merchant ID 251, merchant name 253, latitude/longitude 255, keywords 257 and IP address 259. The merchant ID field 251 contains a unique identifier assigned to the merchant. The latitude/longitude field 255 contains the coordinates of a merchant's locations. These coordinates are compared against a user's location samples to identify selected merchants. In addition, the keywords field 257 contains descriptors relating to a merchant's line of business. Keywords can be used to identify those merchants whose lines of business would or would not be of interest to a user based on either the user's demographics information, as stored in user database 240, or, based on some user-provided instructions concerning types of businesses from whom the user is willing to receive advertisements (also contained in user database 240, but not shown in FIG. 3). The IP address field 259 of merchant database 250 contains the IP address of a merchant server 120. The IP address is used by advertising server 110 to transmit information about users to merchant server 120 via IP network 130.

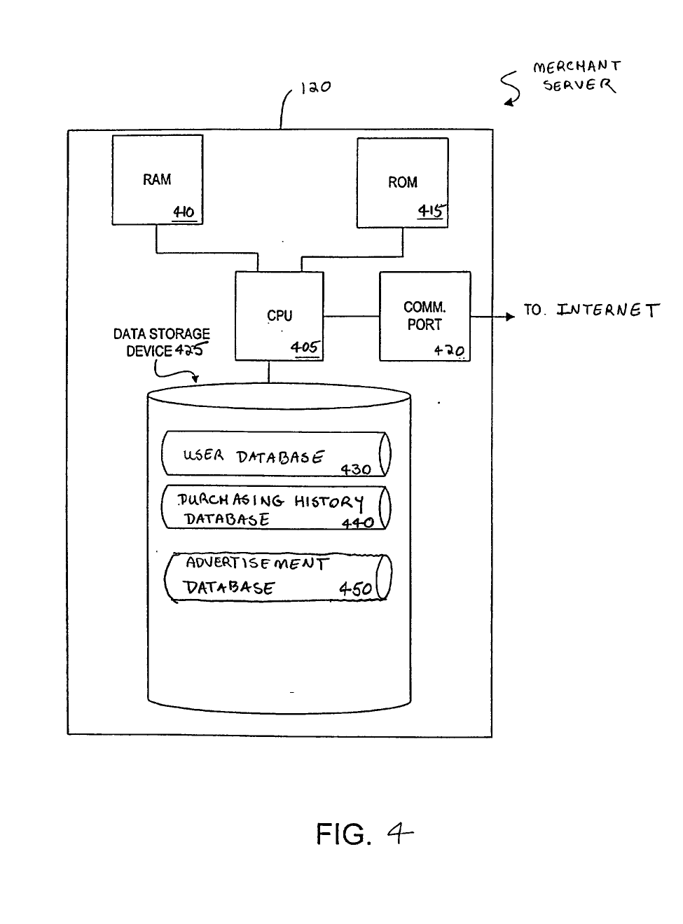

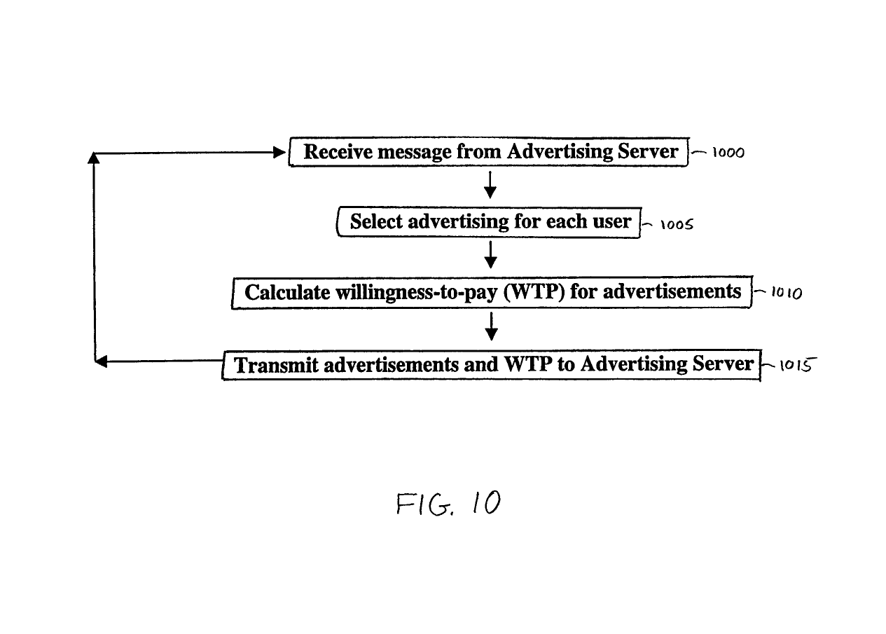

FIG. 4 depicts a block diagram of an exemplary merchant server 120. The server 120 includes a CPU 405 together with associated memory (410, 415) for performing a variety of processes. Briefly, these processes include receiving and storing the identities of users who frequently travel in proximity to the merchant's store and determining whether or not, and how much, to spend to advertise to a user based on factors such as the user's demographics information and purchasing history, as will be discussed in detail below in connection with FIG. 10.

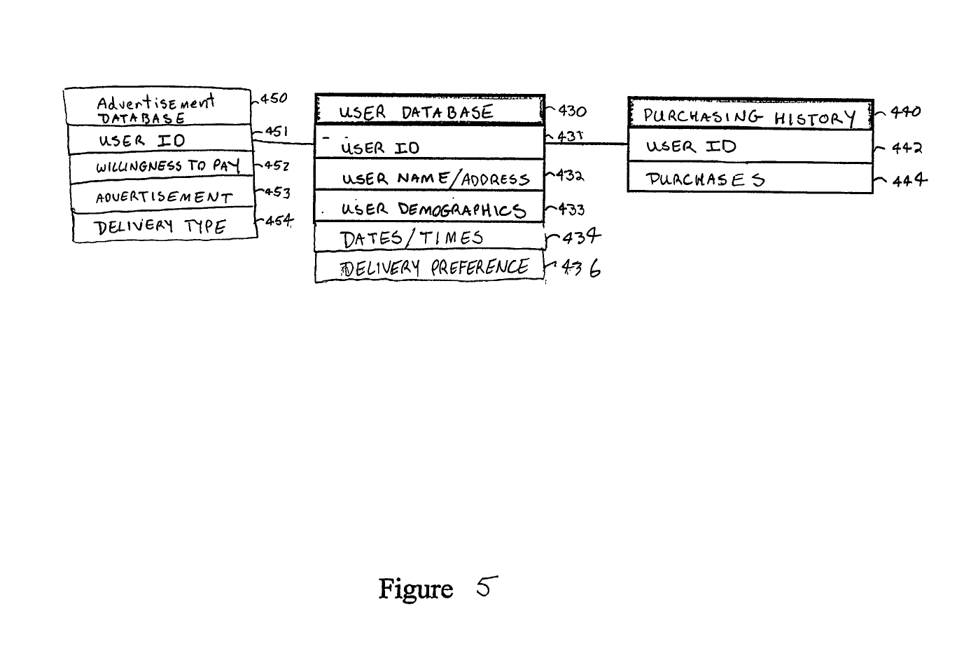

The CPU 405 is coupled to the IP network 130 via a communications port 420, which is used to communicate with advertising servers 110. CPU 405 is also coupled to a data storage device 425. Data storage device 425 includes a variety of databases including user database 430, purchasing history database 440 and advertisement database 450, which will be discussed in detail in connection with FIG. 5.

FIG. 5 illustrates exemplary databases utilized by the merchant server 120. User database 430 stores detailed information about the user. It has fields for a user ID 431, user name/address 432, user demographics 433, date/times of travel in proximity to the merchant's location 434, and a user's delivery preferences 436. These are populated with information received from advertising server 110 upon receipt of an offer from the advertising server 110 to advertise to the user. Of course, advertising server 110 can choose to limit the amount of user contact information (e.g., name, address, etc.) provided to merchant server 120 to prevent merchants from bypassing advertising server 110 and advertising to the users directly.

Purchasing history database 440 includes fields for a user ID 442 and past purchases made by the user from the merchant's store 444. Advertisement database 450 includes fields for a user ID 451, a merchant's willingness to pay 452, an advertisement 453 and delivery type 454. The willingness to pay field 452 stores the amount that the merchant is willing to pay to have the advertising server 110 deliver an advertisement to the user. The advertisement field 453 contains information such as a pointer to a location where the advertisement is stored, and may include, for example, a URL of a web page containing the advertisement. The delivery type 454 stores an indication of the medium used to deliver the advertisement to the user.

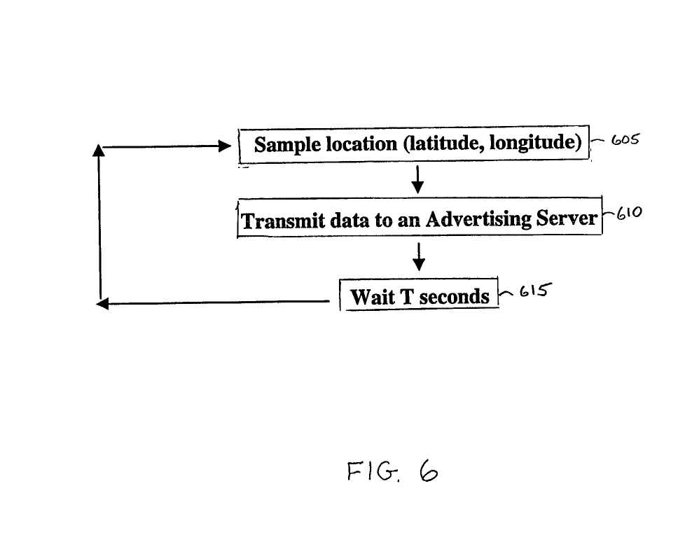

FIG. 6 is a flow chart illustrating an exemplary process by which a mobile IP terminal 100 transmits data including user location information to an advertising server 110. A mobile IP terminal is a portable communications device such as a cell phone, Palm Pilot®, laptop computer or the like with a portable data network access capability and a global positioning system (GPS) capability. In step 605, the mobile IP terminal 100 samples its location by using its GPS capability in a manner well known in the art. See, e.g., U.S. Pat. No. 6,091,857 to Larkins et al., entitled “System and Method for Providing a Geographic Location of a Mobile Telecommunication Unit”, a copy of which is incorporated herein by reference. The location information is stored in the mobile IP terminal's memory, preferably as a pair of latitude and longitude coordinates. In step 610, the mobile IP terminal 100 transmits its terminal ID to advertising server 110 together with the location sample and the date/time of the sample. It will be understood that the mobile IP terminal 100 is configured with the IP address of the advertising server 110 and uses this address when transmitting information to server 110 via IP network 130. In step 615, mobile IP terminal 100 waits a predetermined period of time, such as 30 seconds, before once again sampling its location and transmitting the location sample to the advertising server 110. In this manner, mobile IP terminal 100 keeps advertising server 110 apprised of its location throughout its travels. In one advantageous embodiment, rather than transmitting samples on a sample-by-sample basis, the mobile IP terminal 100 buffers a predetermined number of samples and transmits them to advertising server 110 at the same time. Moreover, in this embodiment, the transmission of samples can be scheduled for non-peak hours when wireless rates are less expensive.

In an alternate embodiment, rather than collecting location samples from mobile IP terminal 100 via a wireless connection, advertising server 110 can collect location samples directly from users via a web interface. For example, there currently exist web interfaces that permit users to specify origination and destination locations, and obtain a map containing those locations together with written driving directions for reaching the destination location from the origination location. These interfaces can easily be modified to enable a user to specify routes followed during his daily commute, and thus, provide advertising server 110 with the location samples needed for merchant selection.

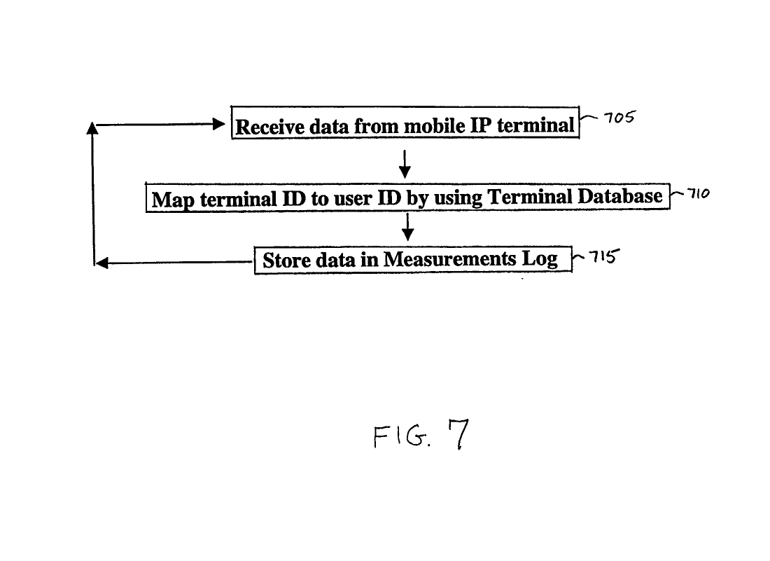

FIG. 7 is a flow chart illustrating an exemplary process by which an advertising server stores data received from a mobile IP terminal. In step 705, the advertising server 110 receives data from a mobile IP terminal 100 via IP network 130. The data includes the terminal ID, a location sample (e.g., latitude and longitude coordinates), and the date/time of the sample. In step 710, advertising server 110 translates the terminal ID to a user ID using terminal database 230. In step 715, advertising server 110 stores the location sample together with the associated date/time in the user's record of measurements log 260. The advertising server will receive and store location samples in accordance with the process of FIG. 7 as often as the mobile IP terminal 100 transmits them, and thus, a detailed record of the user's travels will be stored in measurements log 260 over time. In accordance with one aspect of the present invention, advertising server 110 will periodically purge the oldest location samples in measurements log 260 (e.g., >1 week) to limit the amount of memory needed to maintain the log.

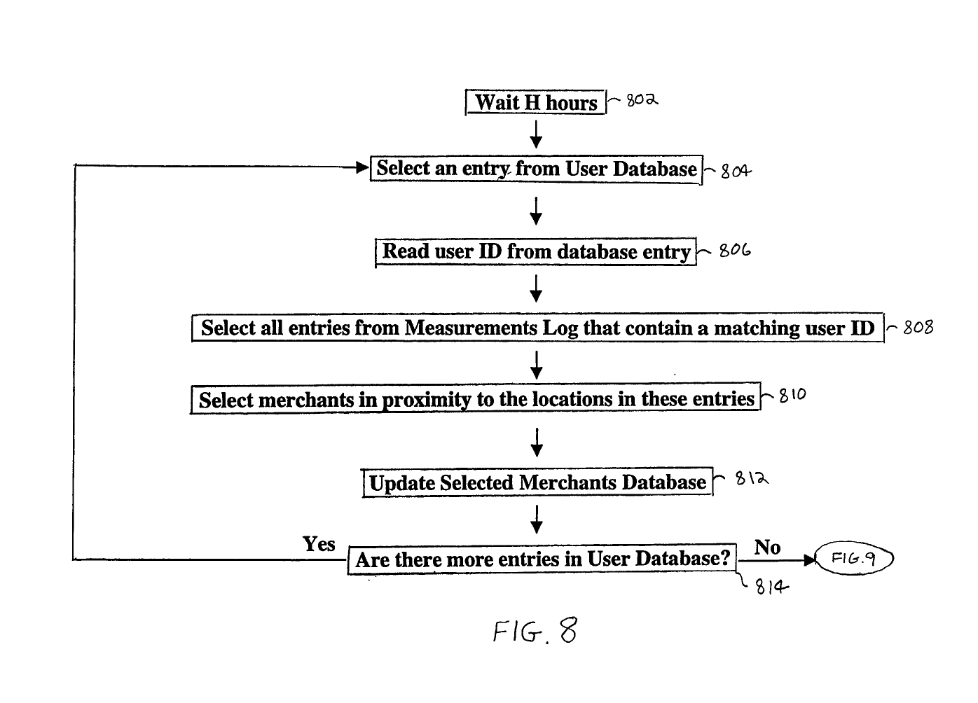

FIG. 8 is a flow chart illustrating an exemplary process by which an advertising server updates the selected merchants database 270 based on location samples received from a mobile IP terminal. As depicted in step 802, advertising server 110 waits a predetermined period of time (e.g., 24 hours, 1 week, etc.) before updating the selected merchants database 270, thus allowing for a sufficient number of location samples to be accumulated in log 260 to warrant an update. In step 804, advertising server 110 selects a record from user database 240. Advertising server 110, in step 806, reads the user ID from field 242. In step 808, advertising server 110 accesses measurements log 260 and, based on the user ID, retrieves the relevant location samples together with the dates/times of the samples from fields 264 and 266, respectively.

In step 810, advertising server 110 accesses merchant database 250 and selects merchants located in proximity to the user's location samples. In other words, server 110 determines those merchants located within a predetermined distance from the location samples. This is accomplished by comparing merchant location information from merchant database 250 with user location samples from measurements log 260. Moreover, a threshold, such as a minimum number of samples whose geographic coordinates are within a predetermined distance from a particular merchant is used to determine whether the user frequently travels in proximity to the merchant. The threshold serves to filter out merchants along routes taken on rare occasions by the user. This is especially useful because a user who infrequently takes a particular route does not represent a valuable potential customer to merchants situated along the route.

In one aspect of the present invention, advertising server 110 ignores certain location samples during merchant selection. For example, advertising server 110 stores geographic coordinates of mass transit routes such as rail lines. It compares location samples received from mobile IP terminals with the geographic coordinates of mass transit routes to identify users of mass transit. In particular, it then ignores location samples of the users that match up with the mass transit routes. The purpose of this is self-evident; users aboard a train travelling at 80 miles per hour are not likely to be interested in advertisements of merchants located along the train routes, since it is impossible for the users to stop and take advantage of any advertised deals. Thus, the advertisements delivered to a commuter are of merchants from whom the commuter is reasonably likely to purchase goods or services, such as those past whose locations the commuter frequently walks or drives, and therefore, can conveniently stop and shop.

Moreover, in an advantageous embodiment, merchant selection takes into account factors in addition to location information, such as the dates and times associated with user location samples. The date/time information can be especially helpful. For example, a restaurant owner who is advertising lunch specials would not be interested in reaching a user who passes his restaurant only in the early morning and late evening when traveling to and from work. Advertising server 110 can also select a merchant based upon a user's demographics information 246 and a merchant's keywords 257. For example, advertising server 110 in all likelihood would not want to select a dog grooming shop for users whose demographics information indicates that they do not own a dog. In addition, the user can identify (e.g., upon registration) the types of merchants from whom he would prefer not to receive advertisements, and, conversely, those from whom he would like to receive advertisements. This user-provided information can also be stored in either demographics field 246 or another field (not shown) of user database 240.

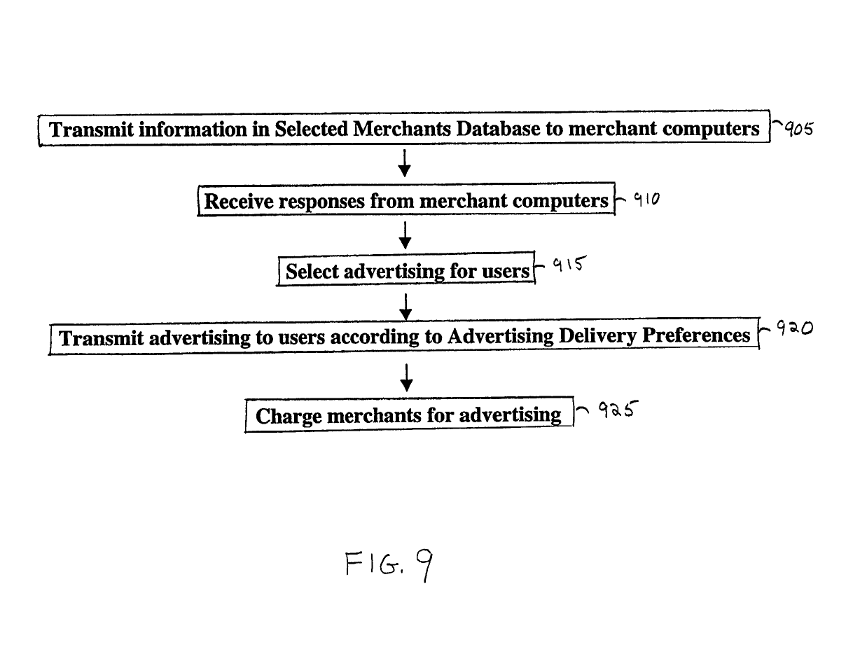

In step 812, advertising server 110 updates the selected merchants database. This involves, for a particular user, adding to the database the merchant IDs of selected merchants (step 810) and the dates/times of the user's travels within a predetermined distance of the merchant's location. In step 814, advertising server 110 determines whether there are any remaining records in user database 240 for which server 110 still needs to update the selected merchants database 270. If records remain, advertising server 110 repeats steps 804 through 812 for each of the records. If no records remain, advertising server 110 proceeds to the process discussed below in connection with FIG. 9.

FIG. 9 is a flow chart illustrating an exemplary process by which an advertising server communicates with selected merchants regarding the delivery of advertisements. In step 905, advertising server 110 transmits to each selected merchant server 120 an “offer” to transmit an advertisement to a user. The offer includes a user ID, an array of date/time entries indicating the dates/times of the user's travels within a predetermined distance of the merchant's store, and the user's demographics information. It will be appreciated that a qualitative descriptor of the array, such as “daily”, rather than the array itself, can be transmitted to merchant server 120. As indicated above, transmission to merchant server 120 is via IP network 130 using the IP address of the merchant server 120. In step 910, advertising server 110 receives responses from merchant servers 120 that are interested in having an advertisement transmitted to the user. A merchant's response includes information such as the user ID, an advertisement, and an indication of the merchant's willingness to pay for delivery of the advertisement. In step 915, advertising server 110 selects one or more of the merchants' responses. The selection of a merchant response by advertising server 110 is based on a variety of factors including how much the merchant is willing to pay for delivery of the advertisement. The advertising server 110 will typically select responses with the highest associated “willingness to pay”. Another factor considered by the advertising server 110 in selecting a merchant response includes whether the advertisement proposed by the merchant complies with the user's delivery preference as indicated in field 248 of user database 240. After having selected responses, in step 920, advertising server 110 transmits the associated advertisements to the user. It will be appreciated that the transmission of an advertisement may employ any medium including e-mail, voice mail, video, facsimile, U.S. mail, etc., and thus, is not intended to be limiting. In step 925, advertising server bills the merchant for delivery of the advertisement to the user.

FIG. 10 is a flow chart illustrating an exemplary process by which a merchant server transmits a response to an advertising server. In step 1000, merchant server 120 receives an offer from advertising server 110 to deliver an advertisement to a user. The offer includes a user ID, an array of date/time entries indicative of the user's travels within a predetermined distance of the merchant's store, and the user's demographics information. In step 1005, merchant server 120 decides whether or not to advertise to the user. If a decision is made to advertise to the user, an appropriate advertisement is selected. Both the decision to advertise to a merchant and the selection of an advertisement may be based upon a variety of factors including the frequency with which the user comes in proximity to the merchant's location as indicated by the array of dates/times transmitted to merchant server 120 by advertising server 110. The decision may also be based upon the user's demographics information, delivery preferences and purchasing history, as stored in merchant server 120. The advertisement selected for delivery is stored in field 453 of advertisement database 450. The stored advertisement may simply be, for example, a URL of a web page containing the advertisement, which advertising server 110 can then deliver to the user via e-mail.

In step 1010, merchant server 120 calculates a willingness to pay (e.g., a dollar amount) for delivery of the advertisement to the user. This may take into account many of the same factors discussed above in connection with advertisement selection—namely, frequency of proximity to the merchant's location, demographics information, delivery preferences and purchasing history. It will be appreciated that each merchant will likely use a different algorithm both to select advertising for users and to calculate a willingness to pay. For example, merchant A may wish to advertise only to commuters who pass its location at least eight times each week and have annual incomes in excess of $100,000. Merchant B, in contrast, may wish to advertise to commuters who pass its location more than five times each month and who are younger than 18 years of age. In step 1015, merchant server 120 transmits a response containing the user ID, advertisement and willingness to pay to advertising server 110.

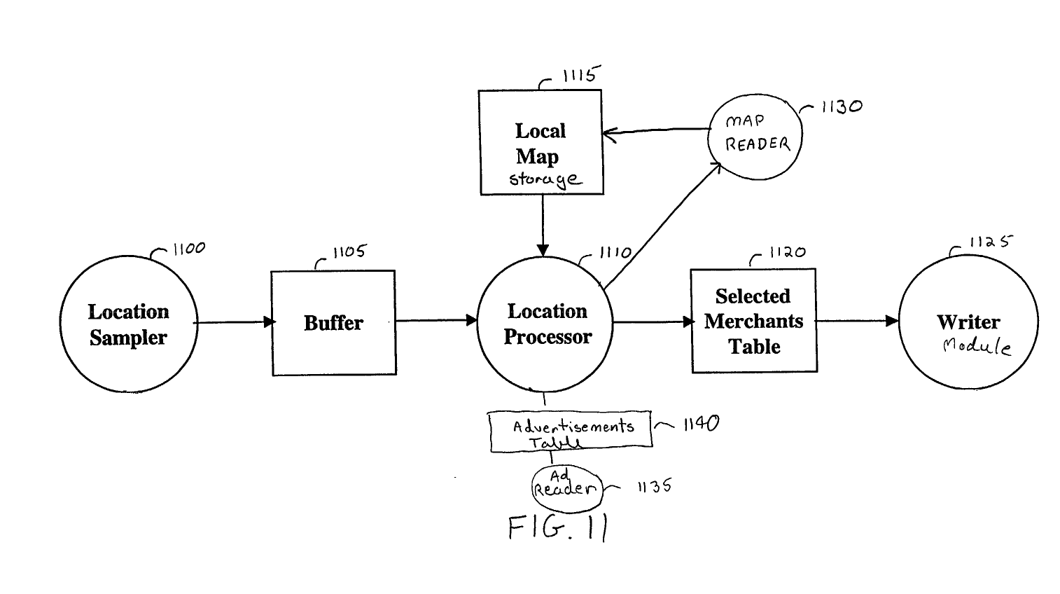

FIG. 11 depicts a block diagram of an enhanced mobile IP terminal of a second embodiment of the present invention. The embodiments discussed until now involve advertising servers 110 performing merchant selection based upon location samples received from mobile IP terminals. In contrast, mobile IP terminals in the instant embodiment perform merchant selection. Briefly, a mobile IP terminal will periodically sample its geographic location, download a local map from advertising server 110 that indicates the location of merchants in the area of the samples, and use this information to select merchants located nearby. Although this embodiment requires a mobile IP terminal with more memory and processing resources than the foregoing embodiments, it has the advantage of significantly reducing the computational load on advertising server 110.

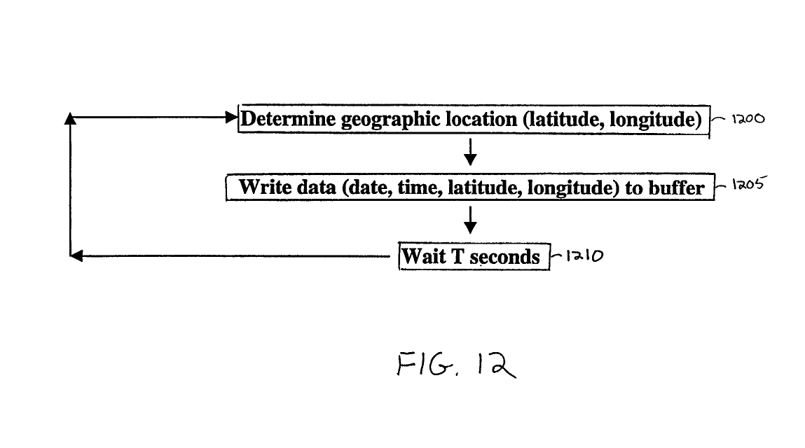

As shown in FIG. 11, an enhanced mobile IP terminal includes location sampler 1100, buffer 1105, location processor 1110, local map storage 1115, selected merchants table 1120, writer module 1125, map reader 1130, advertisement reader 1135 and advertisements table 1140. The operation of these various components will described in detail hereinafter in connection with FIGS. 12-15.

In the present embodiment, communications between advertising server 110 and merchant server 120 will involve the same processes and exchanges of information as in the previous embodiment. In particular, advertising server 110 will provide merchant server 120 with a user ID and an array of dates/times. Merchant server 120 will respond with a user ID, an advertisement, and a willingness to pay. Moreover, advertisements received by module 1135 are selected by advertising server 110 and merchant server 120 in the present embodiment by taking into account information such as user/merchant location information, the frequency of a user's proximity to the merchant's location (based on the array of date/times), demographics information, delivery preferences and purchasing history, in a manner similar to that discussed above in connection with FIGS. 9 and 10. Thus, the discussion of the enhanced mobile IP terminal that follows will focus on the enhanced mobile IP terminal itself and its interactions with advertising server 110a.

FIG. 12 is flow chart illustrating an exemplary process by which the location sampler of the enhanced mobile IP terminal samples the terminal's location. As shown in FIG. 12, in step 1200, location sampler 1100 samples the location of the mobile IP terminal in the manner discussed above in connection with FIG. 6. In step 1205, location sampler 1100 writes the location sample to location buffer 1105 together with the date/time of the sample. In step 1210, location sampler 1100 waits a predetermined period of time before once again sampling its location and writing the sample together with the date/time to buffer 1105.

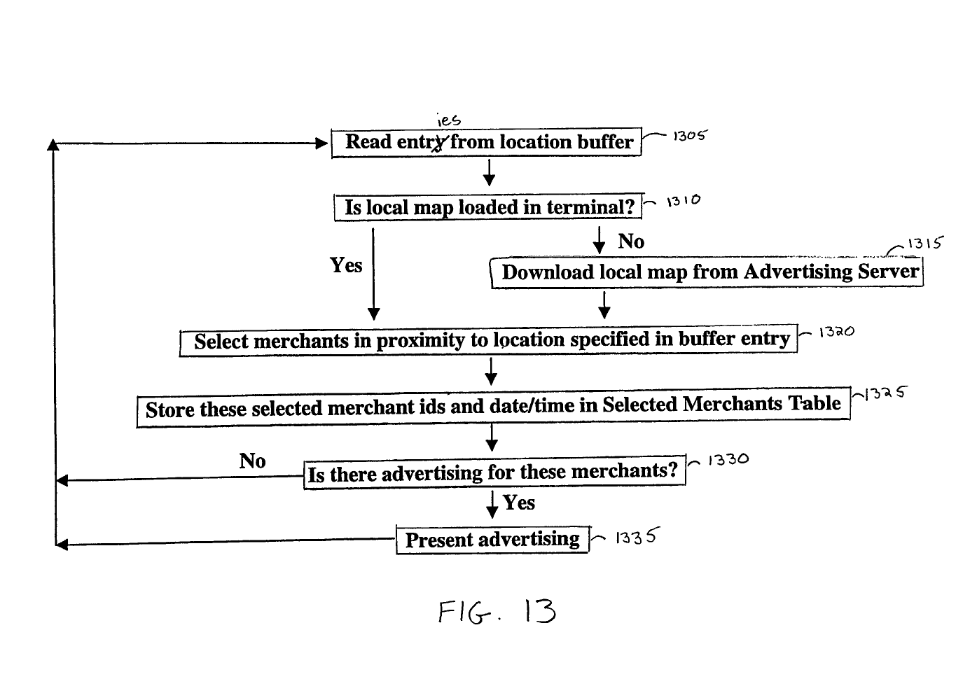

FIG. 13 is a flow chart illustrating an exemplary process by which the location processor of the enhanced mobile IP terminal performs merchant selection and presents advertisements. In step 1305, location processor 1110 reads location samples from location buffer 1105. In step 1310, location processor 1110 determines whether a map local to the location samples is stored in local map storage 1115. This is accomplished by comparing the geographic coordinates of the location samples with the geographic coordinates associated with the stored maps. If a local map is not stored in local map storage 1115, location processor 1110 instructs map reader 1130 to download a local map from advertising server 110 via IP network 130. This is accomplished by providing advertising server 110 with the geographic coordinates of one or more location samples. A map includes the locations of merchants in the area covered by the map together with the merchant identifiers of those merchants. In step 1320, location processor 1110 identifies selected merchants (i.e., one or more of the merchants located in proximity to the location samples). This is accomplished by comparing merchant location information from the map with user location samples from buffer 1105, as discussed above in connection with FIG. 8. Location processor 1110 may also consider additional factors, such as demographics information, in identifying selected merchants, as also discussed above in connection with FIG. 8. In step 1325, location processor 1110 stores the merchant identifiers and the dates and times of the samples in selected merchants table 1120.

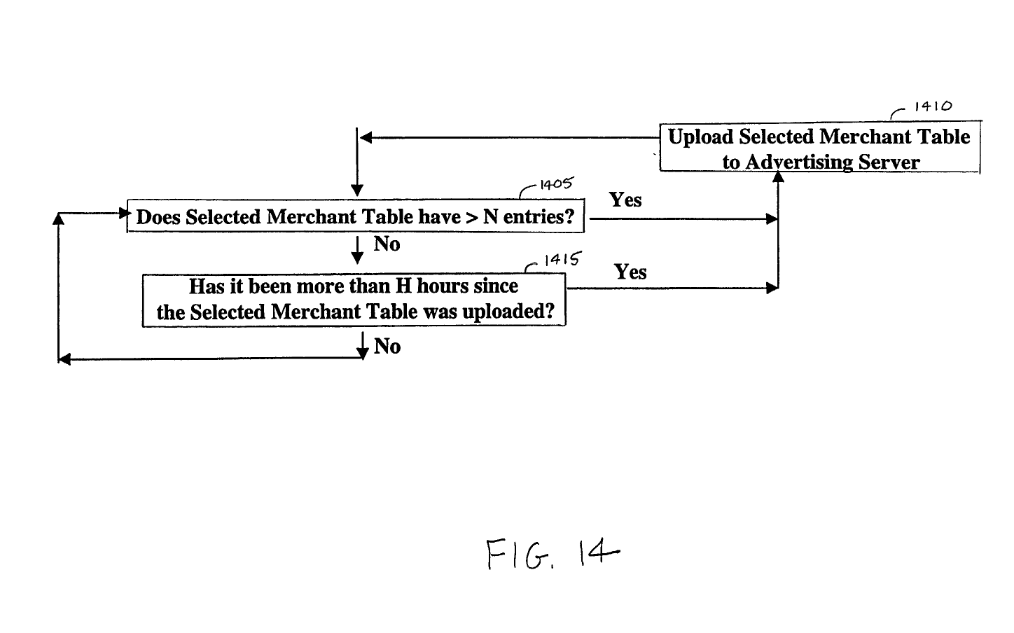

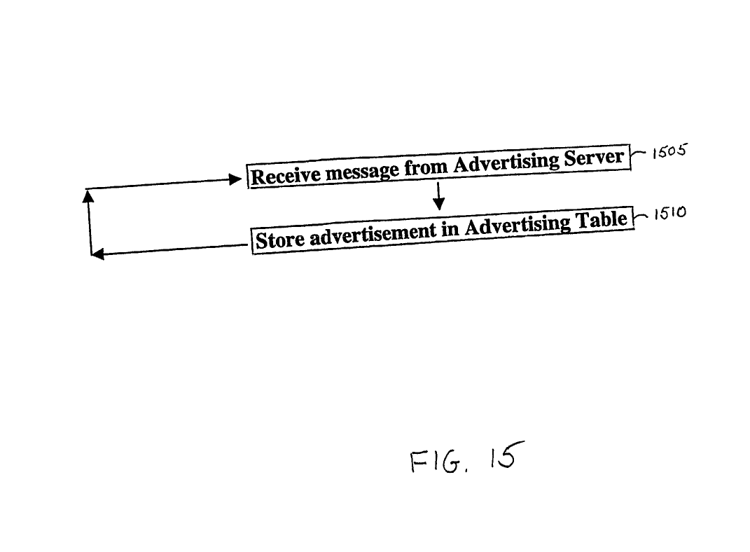

After location processor uploads selected merchant information to advertising server 110a and receives advertisements from server 110a, as discussed below in connection with FIGS. 14 and 15, in step 1330, location processor 1110 determines if there are any advertisements in advertisements table 1140 corresponding to merchant identifiers stored in selected merchants database 1120. If there are no advertisements to present to the user, location processor 1110 returns to step 1305 after a predetermined period of time to process additional samples in location buffer 1105. If, however, there are advertisements to present, location processor 1110, in step 1335, will present them to the user.

FIG. 14 is a flow chart illustrating an exemplary process by which writer module of the enhanced mobile IP terminal uploads entries in selected merchant table 1120 to advertising server 110. In step 1405 of FIG. 14, writer module 1125 determines whether the selected merchant table 1120 contains a predetermined number of entries (each entry includes a selected merchant identifier, the date/times of the samples and the user identifier). In step 1410, if the table contains a predetermined number of entries, writer module 1125 uploads the entries to advertising server 110 together with the corresponding user ID. Otherwise, in step 1415, writer module 1125 determines if a predetermined period of time has elapsed (e.g., H hours) since the entries were uploaded to advertising server 110. If that period of time has elapsed, writer module 1125 uploads the entries to advertising server 110. If the period has not elapsed, writer module 1125 simply returns to step 1405 and repeats the process of determining whether to upload entries.

FIG. 15 is a flow chart illustrating an exemplary process by which the advertisement reader module of the enhanced mobile IP terminal receives and stores advertisements from advertising server 110. In step 1505, advertisement reader module 1135 receives a message from advertising server 110 comprising a merchant identifier and an advertisement. In step 1510, advertisement reader module 1135 stores the advertisement in advertisements table 1140.

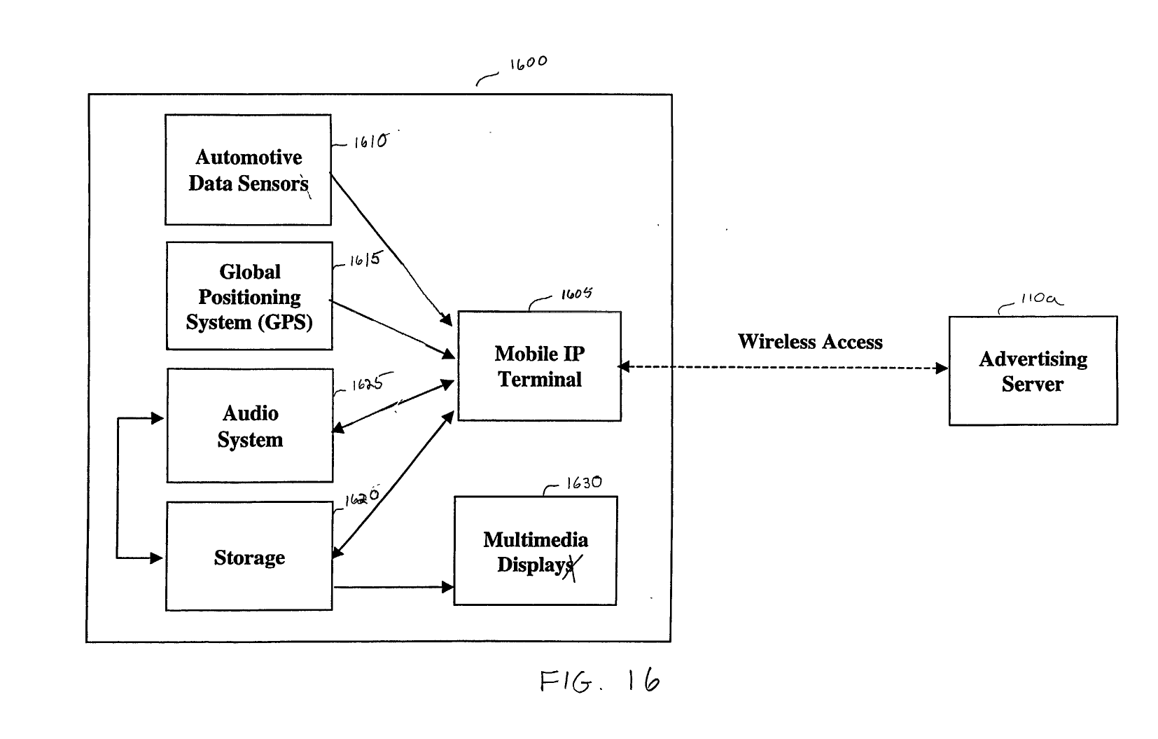

FIG. 16 depicts a block diagram of a “smart” automobile of yet another embodiment of the present invention. As shown in FIG. 16, “smart” automobile 1600 includes various “on-board” systems including mobile IP terminal 1605, automotive data sensors 1610, global positioning system (GPS) 1615, storage 1620, audio system 1625 and multimedia displays 1630.

In one embodiment, mobile IP terminal 1605 is incorporated into “smart” automobile 1600 and communicates with the various other vehicle components over a wired connection. Alternatively, mobile IP terminal 1605 can be carried into the car by a driver or passenger and communicate with the other components using short-range wireless technology, such as “Bluetooth”. Smart automobile 1600 also includes global positioning system 1615, which determines the position of the vehicle. It is used by mobile IP terminal 1605 to calculate location samples.

Mobile IP terminal 1605 also performs merchant selection using local maps as discussed above in connection with FIG. 13. The instant embodiment also includes automotive data sensors 1610 that measure vehicle statistics such as mileage, fluid levels, etc. Mobile IP terminal 1605 then provides advertising server 110a with a user identifier, a selected merchant identifier, dates/times of user location samples and vehicle statistics. Thereafter, communications between advertising server 110a and merchant server 120 in the “smart automobile” embodiment will involve essentially the same processes and exchanges of information as in the previous embodiments, except that in the present embodiment, advertising server 110a uses vehicle statistics for merchant selection, and selected merchants 120 use these statistics to further assist them in deciding whether or not and how seriously to pursue the user as a potential customer. For example, vehicle statistics may be used to identify those commuters who are in need of automotive repairs or routine maintenance.

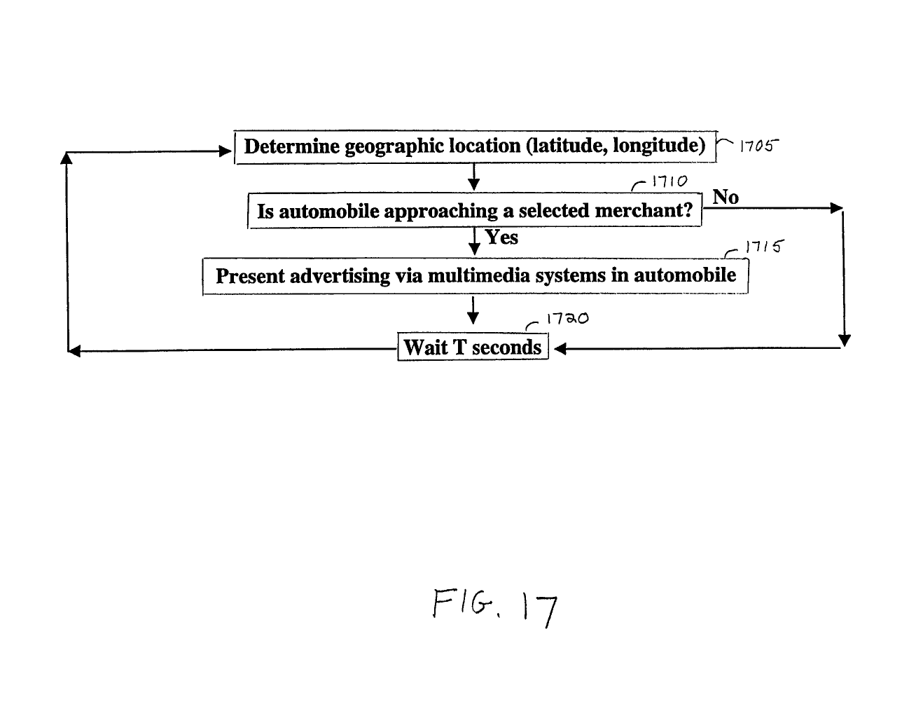

Audio system 1625 is the vehicle's audio system, which, in the instant embodiment, is used to present advertisements received from advertising server 110a. For example, mobile IP terminal 1605 may instruct the audio system 1625 at designated times to interrupt either a received radio transmission or the playback of pre-recorded music (e.g., compact discs, cassette tapes, etc.) for purposes of presenting advertisements. Multimedia display 1630, in contrast, is used by mobile IP terminal 1605 to present multimedia advertisements to passengers, rather than drivers, in an effort to avoid distracting the driver during operation of the vehicle. In addition, advertisements can be presented either at the start of the commute or during the commute. If presented at the start of the commute, mobile IP terminal 110a will check storage 1620 for any advertisements waiting to be delivered to the driver and/or passengers upon vehicle power-on. This approach has the advantage of not interfering with the presentation of music or news reports during the trip. An example of presenting advertisements during a commute is discussed below in connection with FIG. 17.

It will be appreciated that storage 1620 of smart automobile 1600 may readily store user location samples, vehicle statistics, local maps, merchant locations, selected merchant information and advertisements as needed and described above in detail in connection with the first two embodiments of the present invention.

FIG. 17 is a flow chart illustrating an exemplary process by which a smart automobile presents advertisements to a commuter as the commuter approaches a selected merchant. This approach has the advantage of notifying the commuter in real-time as he is approaching a selected merchant. In step 1705, mobile IP terminal 1605 determines the geographic location of the vehicle based on GPS measurements received from GPS 1615. In step 1710, mobile IP terminal 1605 accesses storage 1610 and retrieves the local map containing the latitude/longitude coordinates of selected merchant locations. (If, in an alternate embodiment, merchant selection was performed by advertising server 110a, rather than mobile IP terminal 1605, selected merchant locations would have been transmitted to mobile IP terminal 1605 by advertising server 110a together with the advertisement to be presented to the user.)

Based on the geographic locations of the vehicle and the selected merchants, mobile IP terminal 1605 determines whether the vehicle is approaching a selected merchant. If the vehicle is not approaching a selected merchant, mobile IP terminal 1605 proceeds to step 1720, where it waits a predetermined period of time (e.g., T seconds) before once again determining, in steps 1705 and 1710, its location relative to the locations of selected merchants. If a selected merchant is being approached, in step 1715, mobile IP terminal 1605 retrieves a pre-stored advertisement of the selected merchant from storage 1620 (the advertisement would have been received from advertising server 110 and stored after merchant selection regardless of whether performed by mobile IP terminal 1605 or advertising server 110a), and instructs either audio system 1625 or multimedia display 1630 to present the advertisement to the driver and/or passengers. It will be readily appreciated that rather than retrieving pre-stored advertisements from storage 1620, an advertisement of a selected merchant could be dynamically downloaded from advertising server 110 as the vehicle approaches the selected merchant.

The following are illustrations of how the present invention enables merchants to identify commuters who are likely potential customers:

A bookstore must attract customers to compete effectively with on-line competitors. Joe travels past the bookstore everyday on his commute from work and spends more than $1000 annually on book purchases. The advertising server 110 uses location samples received from Joe's mobile IP terminal 100 together with his demographics information to identify him as a good potential customer.

A retail tire outlet wants to target advertising to hundreds of commuters who travel past its store every day and need new tires. Gail commutes to work in a car whose odometer just exceeded 35,000 miles. The advertising server 110 uses location samples together with the current odometer reading received from her mobile IP terminal 100 to identify that Gail would be a good potential customer.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims. For example, it will be readily appreciated that a data protocol other than the Internet Protocol (IP) can be used for transmission of information between mobile terminals and the advertising and merchant servers. Moreover, in the “smart automobile” embodiment of the present invention, it will be understood that merchant selection based on the location samples and other information such as vehicle statistics can alternatively be performed remotely by advertising server 110a as discussed above in connection with the first embodiment of the present invention.

I claim:

1. A method of selecting merchants for transmission of advertising information to a user of a mobile wireless terminal, comprising:
comparing a plurality of geographic location samples of a wireless terminal with a geographic location of a seller to determine whether said wireless terminal has frequently traveled in proximity to said seller; and
if said wireless terminal has frequently traveled in proximity to said seller, selecting said seller as an entity that may be interested in having an advertisement transmitted to a user of said terminal.

2. The method of claim 1 wherein determining whether said wireless terminal has frequently traveled in proximity to said seller involves determining whether a predetermined number of said geographic location samples are within a predetermined distance of said seller.

3. The method of claim 1 wherein said step of selecting said seller is dependent upon timing information associated with said wireless terminal's travels in proximity to said seller.

4. The method of claim 1 wherein said step of selecting said seller is dependent upon demographics information of said user of said wireless terminal.

5. The method of claim 1 wherein said step of selecting said seller is dependent upon whether said seller is of the type seller from whom said user is willing to accept advertisements.

6. The method of claim 1, further comprising:
excluding one of said plurality of geographic location samples of said wireless terminal from said step of comparing.

7. The method of claim 6 wherein said plurality of geographic location samples that are excluded from said step of comparing corresponds to a plurality of locations along a mass transit route.

8. The method of claim 1 wherein said geographic location of said seller is determined from a map local to one of said plurality of geographic location samples of said wireless terminal.

9. The method of claim 1 wherein said plurality of geographic samples of a wireless terminal are represented by latitude and longitude coordinates.

10. A method of conveying advertising information to users of mobile wireless terminals, comprising:
receiving location samples of a mobile wireless terminal;
processing said location samples to determine whether said wireless terminal frequently travels in proximity to a seller; and
transmitting an advertisement of said seller to a user of said wireless terminal.

11. The method of claim 10, wherein said transmitting step occurs if said wireless terminal frequently travels in proximity to said seller.

12. The method of claim 10 further comprising:
receiving an indication of said seller's willingness to pay for transmission of said advertisement to said user of said wireless terminal.

13. The method of claim 12 wherein said transmitting step occurs if said seller's willingness to pay exceeds a predetermined amount.

14. The method of claim 10 wherein said location samples of said wireless terminal are received via a web interface.

15. The method of claim 10 wherein said advertisement is transmitted using a medium from the group consisting of e-mail, voice mail, facsimile, paper, banner ads and television commercials.

16. The method of claim 15 wherein said advertisement is transmitted to said user of said wireless terminal in accordance a user delivery preference.

17. The method of claim 10 further comprising:
making an offer to said seller to advertise to said user of said wireless terminal.

18. The method of claim 10 further comprising:
purging location samples after a predetermined period of time.

19. A method of conveying advertising information to buyers, comprising:
determining if a buyer is traveling in proximity to a seller; and
if demographics information of said buyer satisfies predetermined criteria, transmitting an advertisement of a seller to said buyer.

20. A method of conveying advertisements to a commuter in a vehicle, comprising:
receiving vehicle statistics;
transmitting said vehicle statistics to a selected merchant;
receiving an advertisement of said selected merchant; and
presenting said advertisement to said commuter.

21. The method of claim 20 wherein said selected merchant is a merchant with a location that said commuter frequently travels in proximity of.

22. The method of claim 20 further comprising:
transmitting information to said selected merchant regarding the frequency with which said commuter is in proximity to a location of said selected merchant.

23. The method of claim 20 further comprising providing said selected merchant with an opportunity to advertise to said commuter.

24. The method of claim 20, wherein said advertisement is presented as said commuter's commute commences.

25. The method of claim 20, wherein said advertisement is presented during said commuter's commute.

26. The method of claim 25, wherein said advertisement is presented as said vehicle is approaching a location of said selected merchant.

27. The method of claim 20, wherein said advertisement is a multimedia advertisement.

28. The method of claim 20, wherein said advertisement is presented to said commuter via an audio system in said vehicle.

29. The method of claim 20 wherein said steps of transmitting and receiving are performed over a wireless connection using a data protocol.

30. A method for a merchant to advertise to a user of a mobile wireless terminal, comprising:
receiving information regarding the frequency with which said commuter is in proximity to a location of said merchant;
selecting an advertisement to be transmitted to said user; and
transmitting said advertisement to an advertising server.

31. The method of claim 30 further comprising:
calculating a willingness to pay for transmission of said advertisement to said user; and
transmitting said willingness to pay to said advertising server.

32. The method of claim 31 wherein said willingness to pay is based upon a purchasing history of said user.

33. A system comprising:
a memory device storing a program; and
a processor in communication with the memory device, the processor operative with the program to:
compare a plurality of geographic location samples of a wireless terminal with a geographic location of a seller to determine whether said wireless terminal has frequently traveled in proximity to said seller; and
if said wireless terminal has frequently traveled in proximity to said seller, select said seller as an entity that may be interested in having an advertisement transmitted to a user of said terminal.
